(19) United States
(12) Patent Application Publication
(10) Pub. No.: US 2025/0180076 A1
(43) Pub. Date: Jun. 5, 2025

(54) COUPLING

(71) Applicant: Punk Couplings Limited, Bristol (GB)

(72) Inventor: Simon PARKER, Bristol (GB)

(21) Appl. No.: 19/052,007

(22) Filed: Feb. 12, 2025

Related U.S. Application Data
(63) Continuation of application No. 17/767,172, filed on Apr. 7, 2022, now abandoned.

(30) Foreign Application Priority Data
Oct. 9, 2019 (GB) 1914612.5
Dec. 10, 2019 (GB) 1918106.4
Jan. 30, 2020 (GB) 2001273.8
Jan. 30, 2020 (GB) 2001274.6
Apr. 30, 2020 (GB) 2006345.9

(51) Int. Cl. F16D 3/42; F16D 3/205; F16D 3/43; F16D 3/44; F16D 3/68; F16D 3/78

(52) U.S. Cl. CPC F16D 3/42; F16D 3/2052; F16D 3/43; F16D 3/44; F16D 3/68; F16D 3/78

(57) ABSTRACT

A coupling has an inner member and an outer annular member and an intermediate annular member which when aligned share a common axis and have a common centre on the common axis. The inner and the intermediate annular member are constrained to rotate, one with respect to the other about a second axis perpendicular to the common axis. The intermediate annular member and the outer annular member are constrained to rotate, one with respect to the other about a third axis perpendicular to the common axis and the second axis. The members are spaced apart to leave a gap between each of the members.

### CROSS-REFERENCE TO RELATED APPLICATION

This application is a continuation of U.S. patent application Ser. No. 17/767,172, filed Apr. 7, 2022, pending, which is the U.S. national phase of PCT International Patent Application No. PCT/GB2020/052491 filed Oct. 8, 2020 which designated the U.S. and claims priority to Great Britain Patent Application No. 1914612.5 filed Oct. 9, 2019, Great Britain Patent Application No. 1918106.4 filed Dec. 10, 2019, Great Britain Patent Application No. 2001273.8 filed Jan. 30, 2020, Great Britain Patent Application No. 2001274.6 filed Jan. 30, 2020, and Great Britain Patent Application No. 2006345.9 filed Apr. 30, 2020, the entire contents of each of which are hereby incorporated by reference.

### TECHNICAL FIELD

The present invention relates to a coupling.

### BACKGROUND ART

WO2015/087081 (Punk Couplings Limited) describes and claims a coupling having an inner member and an outer annular member and comprises:
one or more pairs of annular members, which may or may not include one or both the inner and outer annular members, each pair being a first annular member and a second annular member with a common axis and having a common centre on the axis;
the first annular member having an outer convex spherical periphery; the second annular member having an inner spherical concave periphery in which the outer convex periphery of the first annular member is received; the outer convex periphery and the inner concave peripheries being concentric about the centre and complementary to one another and co-acting with one another to transmit axial loads acting along the torsional axis between them; one or a diametrically opposed pair of axles disposed radially of the common centre of the pair of annular members coupling the first and second annular members for transmitting torsional load from one of the annular members to the other; the first and second annular members being constrained by the axle(s) to be rotatable one relative to the other about the axle(s).

In some circumstances where substantial loads are generated in such a coupling, concern may arise over long-term wear on the surfaces of the complementary surfaces. Furthermore, losses through friction as a result of contact between the complementary surfaces impacts upon the efficiency of the coupling.

It is also known to utilise both the torsional damping properties of a rubber ring element to absorb the engine pulses when coupling misaligned shafts, but this is achieved by utilising the out of plane ‘twist’ capability inherent in rubber ring design. However, this creates an imbalance in the system, with extra forces that need to be overcome therefore inducing inefficiencies and unnecessary stresses and, therefore noise/vibrations in the system. An example of such a coupling is seen in EP0063022A (Dunlop Limited) published 20 Oct. 1982. In consequence of the limitations of such a coupling, the angular misalignment is limited to 2° or 3°.

### DISCLOSURE OF INVENTION

According to the present invention, a coupling comprising:
an inner member and an outer annular member and an intermediate annular member which when aligned share a common axis and have a common centre on the common axis;
the inner member having an outer convex periphery, the intermediate annular member having an inner concave periphery in which the outer convex periphery of the inner member is received; the outer convex periphery of the inner member and the inner concave periphery of the intermediate annular member having the same common axis when the coupling is aligned; one or a diametrically opposed pair of first axle(s) disposed radially of the common centre coupling the inner member and the intermediate annular members, and the inner member and the intermediate annular member being constrained by the first axle(s) to rotate, one with respect to the other about a second axis perpendicular to the common axis; and
the intermediate member having an outer convex periphery, the outer annular member having an inner concave periphery in which the outer convex periphery of the intermediate member is received; the outer convex periphery of the intermediate member and the inner concave periphery of the outer annular member having the same common axis when the coupling is aligned;
a diametrically opposed pair of second axles disposed radially of the common centre coupling the intermediate annular member and the outer annular member, the intermediate annular member and the outer annular member being constrained by the second axles to rotate, one with respect to the other about a third axis perpendicular to both the common axis and the second axis; is characterised in that the inner member, intermediate annular and outer annular member are spaced apart to leave a gap between each of the members.

In one embodiment, the coupling is one of two such couplings sharing a common centre and in that the outer annular member of one coupling is the inner member of the other coupling.

In another embodiment. The coupling is one of two such couplings in which the inner members are disposed around a common shaft. This embodiment would be a direct and more efficient replacement for a standard Cardan shaft coupling.

In addition to reducing friction and wear, the invention has the additional benefit on ensuring maintenance of the concentricity of the pairs of annular members.

In contrast to WO2015/0087081 where the spherical surfaces of the first and second annular members carry most of any axial and radial load is carried by the spherical surfaces, in the present invention the axles also carry the axial and radial loads.

Couplings according to various embodiments of the present invention may be used for coupling any two structural elements that must be coupled with at least one rotational degree of freedom. Some examples are useful as structural static couplings, that is coupling an element to a fixed structure. Other examples are useful as rotational flexible couplings coupling two rotational elements. Couplings according to the invention, for example, may be used to couple angularly misaligned shafts, or as universal joints, constant velocity joints, couplings for coupling a drive shaft to a driven shaft, and as couplings for connecting to a pack and pinion or power steering actuator in a vehicle steering system.

In a further development of the invention the coupling additionally comprises a pulse damper disposed are around the central axis, said pulse damper a first end plate and a second end plate parallel and opposed to one another, the first end plate being connected an input or output and the second end plate to the outer annular member, one of the said end plates has an axle centred on the central axis extending therefrom towards the other of said end plates, the other of said end plates having a tube extending therefrom around the axle and forming a housing for a plurality of bearings between the tube and the axle; and a damping ring comprising an even number of dividers disposed equidistantly from one another around the tube, the dividers having elastomeric material between them; alternate dividers being fixed to the first end plate from which the axle extends, the other dividers being fixed to the co-axial tube.

Other features and embodiments of the invention are set out in the accompanying description and claims.

### BRIEF DESCRIPTION OF DRAWINGS SHOWING EXAMPLES OF THE INVENTION

FIG. 1 is a side view of two couplings each according to the invention with their inner members sharing a common axle;

FIG. 2 is a vertical section through the couplings of FIG. 1;

FIG. 3 is a section though the couplings of FIG. 1, the section being orthogonal to that of FIG. 2;

FIG. 4 is a section through one of the couplings of FIG. 1, the section being on the plane that is orthogonal to the sections of FIGS. 2 and 3; and

FIG. 5 shows two concentric couplings incorporating the invention;

FIG. 6 is a perspective view of a misaligned coupling of FIG. 1 incorporating a pulse damper;

FIG. 7 is a perspective view of the damping ring of FIG. 6;

FIG. 8 is a section through the axis of the aligned coupling and pulse damper of FIG. 6;

FIG. 9 is an exploded view of the pulse damper of FIG. 6 alone; and

FIG. 10 is a vertical section of the pulse damper of FIG. 6 on a plane orthogonal to that of the section of FIG. 8.

### DESCRIPTION OF EXAMPLES

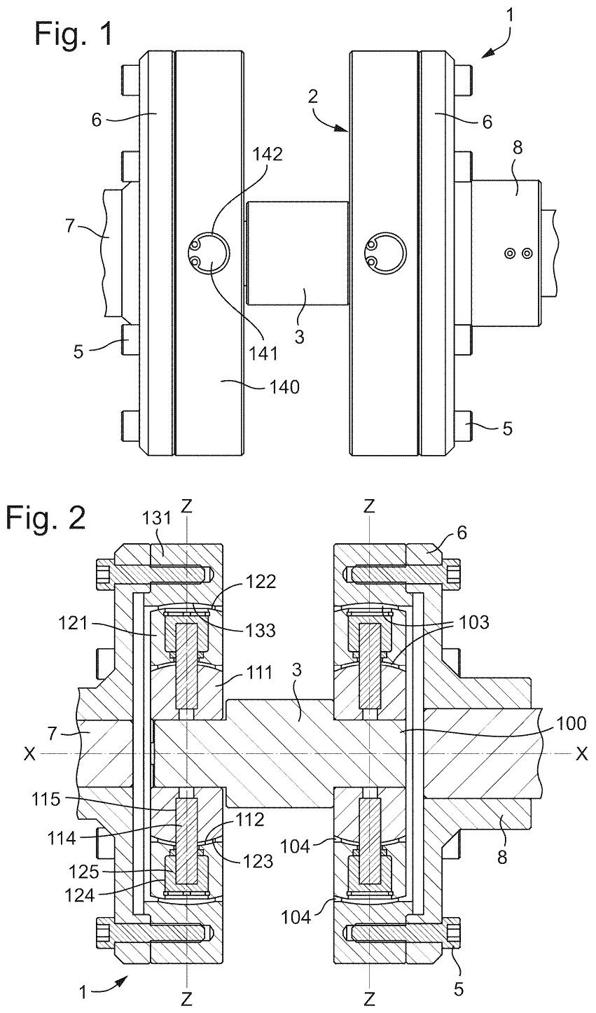

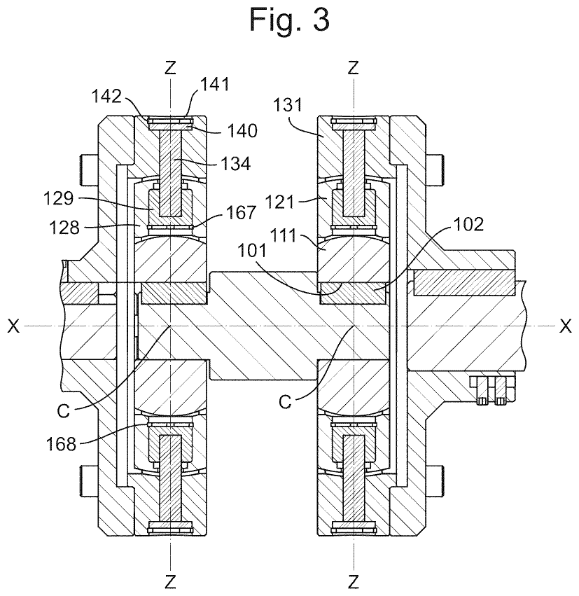

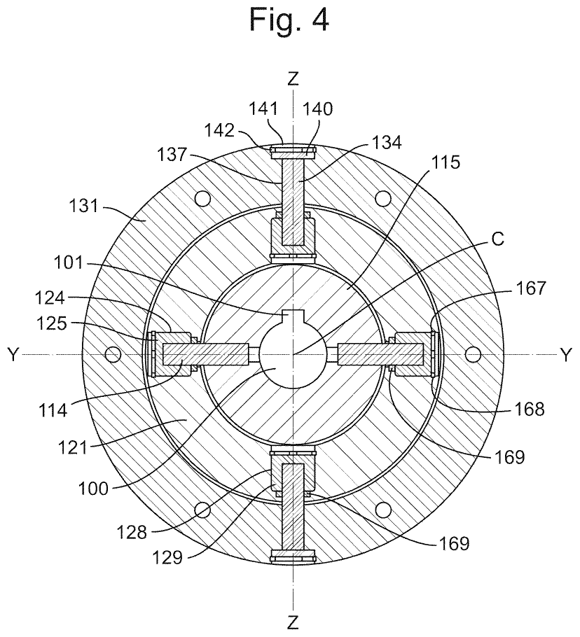

FIGS. 1 to 4 show two example couplings 1 and 2 of the invention link by a shaft 3 used as a Cardan shaft replacement.

Each coupling 1 and 2 comprises an inner annular member 111, an intermediate annular member 121, and an outer annular member 131. The inner member 111 is centred on the central axis X. The inner member 111 has a convex outer peripheral surface 112 which is convexly spherical centred on a point C on the central axis X.

The inner annular member 111 has a central aperture 100 to receive shaft 3. The central apertures 100 has a keyway 101 engaged by a corresponding key 102 on the shaft 3. Alternatively, the end of the shaft 3 may have splines to engage corresponding splines around the central aperture.

The intermediate annular member 121 has an inner concave peripheral surface 123 which is a spherical segment complementary to the convex outer peripheral surface 112 of the inner member 111. The concave surface 123 is also centred on point C. Diametrically opposed axles 114 extend radially of the axis X along second axes Y, which are orthogonal to the axis X, second axes Y pass through the point C

An axle 114 extends through the inner member 111 into the intermediate member and couples the inner member 111 to the intermediate annular member 121. The axle 114 constrains the intermediate annular member 121 to rotate with respect to the inner member 111 about the second axes Y.

The intermediate annular member 121 has an outer periphery 122 which is convexly spherical centred on point C. The outer annular member 131 has an inner concave peripheral surface 133 which is concavely spherical and centred on point C complementary to the convex outer periphery 122 of the intermediate member 121. A pair of diametrically opposed axles 134 extend radially of the central axis X on third axis Z, the third axis Z being orthogonal to the axis Y and axis X. The diametrically opposed axles 134 couple the intermediate annular member 121 to the outer annular member 131. Third axis Z passes through the same centre point C as the central axis X and second axes Y.

The axles 134 constrain intermediate annular member 121 and outer annular member 131 to rotate one relative to the other about axis Z. The axles 134 allow relative rotation of intermediate annular member 121 and outer annular member 131 independently of the relative rotation of the inner member 111 and intermediate annular member 121.

The axle 114 is supported in capped needle bearings 125 mounted in bores 124 in intermediate member 121 and fixed in a bore 115 in the inner member 111.

The axles 134 are fixed in bores 137 in the outer annular member 131 and are supported in capped needle bearings 129 fixed in bores 128 in the intermediate annular member 121.

The thicknesses of the members 111, 121 and 131 are chosen so that a small gap 103 is left between the convex and concave outer and inner peripheries 112 and 123 of the inner member 111 and the intermediate annular member 121; and similarly a small gap 103 is left between the convex and concave outer and inner peripheries 122 and 133 of the intermediate annular member 121 and the outer annular member 131 respectively. Therefore, the inner and outer surfaces of the members do not touch one another. However, should a failure occur the inner members and the intermediate annular member will be retained within the structure of the coupling 1.

Loading slots 104 (marked in FIG. 2) are provided to allow the inner member 111 to be inserted within the intermediate annular member 121 and the intermediate annular members 121 to be inserted in the outer annular members 131.

The capped needle bearings 125 and 129 have circlips 167 fitted around their periphery near their closed ends engaging with corresponding groves 168 in the surface of holes 124 and 128. The circlips 167 are used to retain the bearings 125 and 129 against the centrifugal forces generated when the coupling 1 spinning at high speed. Seals 169 are positioned to bridge the gap between the bearings 125 and 129 and the axles 114 and 134 to prevent ingress of contaminants into and the egress of lubricant from the bearings.

The axles 134, each have a flange 140 at their outer ends. The flanges 140 sit in seats 141 in the outer surface of the outer annular member 131. Circlips 142 engage with the inner periphery bores 137 against the flanges 140 to hold the axles 134 firmly in place.

The outer annular member 131 of coupling 1 has bolt holes in which bolts 5, passing through the end flange 6 of a drive or driven shaft 7, couple the shaft 7 to the outer annular member 131.

In the configuration shown in FIGS. 1 to 5, the outer annular member 131 of coupling 2 also has bolt holes in which bolts 5, passing through the end flange 6 of a second drive or driven shaft 8, couple the shaft 8 to the outer annular member 131 of the second coupling 2.

As a further alternative rather than the inner member of one of the couplings being an annular member, it can be formed as male member having a boss with the shaft 3 extending from the boss into the central aperture of the other coupling.

As another alternative, the axles 114 and 134 are supported in bearings in the inner and outer members 111 and 131 respectively, rather than in the intermediate member 121.

In FIGS. 1 to 5, a coupling of the invention is shown as being one of two linked by a common shaft to replace a Cardan coupling. But the coupling as shown as 1 or 2 can be used singly, with one of shafts 3 and 7 being the drive shaft and the other being the driven shaft. As a further alternative, rather than being bolted to a shaft, the other annular member may be connected to another rotatable device.

When two couplings 1 and 2 are connected as shown in FIG. 1 by a shaft 3, the rotational speed of one of the drive or driven shafts 7 and 8 will be the same as that of the other of the shafts 7 and 8 whatever the misalignment between shafts 7 and 8

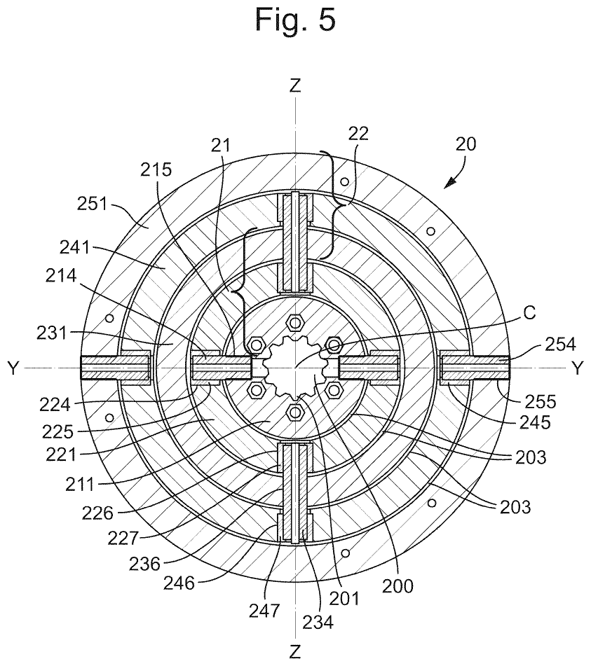

In FIG. 5, a double concentric joint 20 made up of two couplings 21 and 22 each incorporating the invention, one mounted inside the other, the outer annular member of the inner coupling 21 is the inner member of the outer coupling 22 and is hereafter called the common member 231. The couplings 21 and 22 have a common centre C.

Coupling 21 comprises an inner member 211, which, in this example, is annular, having a central bore 200 with splines 201 around the bore to receive a splined drive or driven shaft (not shown), an outer annular member-namely the common annular member 231 and an intermediate member 221.

Coupling 22 comprises an inner annular member-namely the common annular member 231, an intermediate member 241 and an outer annular member 251.

The inner member 211, in this example is annular, the intermediate members 221, 241 and the common annular member 231 comprise spherical segments. Each of the members (211, 221, 231, 241, 251) is disposed around a common central axis X and has a common centre C on the common axis X.

The outer annular member 251 has bolt holes on its side to receive bolts passing through an end flange of a shaft (not shown) to be coupled to the outer annular member.

The inner member has an outer convex spherical periphery 212 and the intermediate annular member 221 of coupling 21 has an inner spherical concave periphery 223 in which the outer convex periphery 212 of the inner member 211 is received.

The intermediate annular member 221 has an outer convex spherical periphery 222 and the common annular member 231 has an inner spherical concave periphery 233 in which the outer convex periphery 222 of the intermediate annular member 221 is received.

The common annular member 231 has an outer convex spherical periphery 232 and the intermediate annular member 241 of coupling 22 has an inner spherical concave periphery 243 in which the outer convex periphery 232 of the common annular member 231 is received.

The intermediate annular member 241 of the second coupling 22 has an outer convex spherical periphery 242 and the outer annular member 251 has an inner spherical concave periphery 253 in which the outer convex periphery 242 of the intermediate annular member 241 is received.

The outer convex peripheries (212, 222, 232, 242) and the inner concave peripheries (223, 233, 243, 253) are concentric about the centre C and are complementary to one another.

A pair of diametrically opposed axles 214 extend from opposed bores 215 in the inner member 211 into bearings 225 fixed in bores 224 in the intermediate annular member 221. The axis Y of the axles 214 is perpendicular to the common central axis X. The intermediate annular member 221 of coupling 21 is constrained to rotate about the inner member 211 about the second axis Y perpendicular to the common axis X.

A pair of diametrically opposed axles 234, whose common axis Z is perpendicular both to the common central axis X and the second axis Y, is fixed in opposed bores 236 in the common annular member 231 and mounted in bearings 227 and 247 fixed in bores 226 in the intermediate annular member 221 of coupling 21 and bores 246 in the intermediate annular member 241 of coupling 22. The common annular member 231 thus is constrained to rotate about the intermediate annular member 221 and the intermediate annular member 241 about the common annular member 231 on a third axis Z perpendicular to both the common axis X and the second axis Y.

A pair of diametrically opposed axles 254 extend from opposed bores 255 in the outer annular member 251 into bearings 245 fixed in bores 244 in the intermediate fourth annular member 241. The axis of the axles 254 is aligned with the second axis Y perpendicular to the common central axis X. The outer annular member 251 thus is constrained to rotate about the intermediate annular member 241 about the second axis Y and perpendicular to the common axis X.

The bearings 225, 245, 227, 247 can be plain bearings or capped roller needle bearings.

The dimensions of the members 211, 221, 231, 241 and 251 and axles 214, 234 and 254 are chosen to provide a small gap 203 between each convex outer periphery and each concave inner periphery. The gaps 203 between the members and concentricity of the members is maintained by the ends of the axles 214 and 254 being fixed by an interference fit in bores 215 and 255 respectively in inner and outer members 211 and 251 and supported by bearings 225 and 245 in the intermediate annular members 221 and 241, and also by axles 234 being fixed in bores 236 in the common annular member 234 by having an interfering fit therein and at either end of the axles by bearings 227 and 247 in the intermediate members 221 and 241. The axles and bearings can also be retained by circlips, snap rings, pins, or bolted caps.

The members 211, 221, 231 and 241 are loaded in turn within the members 221, 231, 241 and 251 using opposed loading slots 202 by inserting in a direction parallel to the common central axis, then rotating the smaller member into position. The axles are then located in position.

The common annular member 231 transmits rotational motion and torque from one coupling 21 to the other 22 or vice-versa.

The coupling of FIG. 5 is a female coupling in that any connecting shaft is inserted into the central aperture 200, with connection made to the splines 201. By replacing annular member 211 with a boss having a shaft extending laterally from the boss, connection made to an input or output externally.

In all the examples, the appropriate width of the gaps 103 and 203 in all the examples is a matter of design for the intended application varies according to the intended use of the coupling, the speed of rotation, load profiles, and the materials used in the annular members. However, as a general rule, the gaps 103 or 203 would be 0.5% of the overall diameter of the coupling where the overall diameter is less than 100 mm, and 1% of the overall diameter for couplings 100 mm in diameter or more.

In the examples, Ideally, the inertial mass of the members reduces the further away from the central axis X, is the member. This can be done through choice of materials, adding holes to intermediate and outer members as required, and/or by making the intermediate members thinner than the inner members and the outer members in turn thinner that the intermediate members. This ensures that the inertial mass of the intermediate members and outer members is reduced by comparison with what they would have been had all the members been of the same material.

Further measures to reduce the inertial mass of rotating parts of the away from the central axis X include the axles 134 and 234 being of smaller diameter than axles 114 and 214, and axles 254 being of smaller diameter than axes 234.

Couplings as described above may be made of any suitable material, although, in design regard should be taken of the desirability of reducing the inertial mass of members as distance from the central axis X increases.

If plain capped bearings are used, the surfaces may be of metal, e.g. high-performance steels, brass, bronze, aluminium, titanium etc. or of plastic, e.g. nylon, glass filled nylon, acetal, ABS, Delrin®.

Metal annular members may be lubricated by conventional lubricants for example grease. Alternatively, dry lubricant surfaces such as plastic liners may be used. The choice of materials and lubricants depends on the intended use of the coupling.

In FIGS. 1 to 5, as described, the outer peripheries of members 111 and 121, and of members 211, 221, 231, and 241 are convex spherical peripheries and the inner peripheries of members 121 and 131, and of 221, 231, 241, and 251 are concave spherical peripheries. As contact between the members can be avoided by having the gap 203 maintained by the axles between the members and if that gap is sufficiently large, the peripheries surfaces can be cylindrical; alternatively, the peripheries can be chamfered towards their edges. The axles 114 and 134, and 214, 234 and 254 maintaining the gaps also maintain the concentricity of the members of couplings.

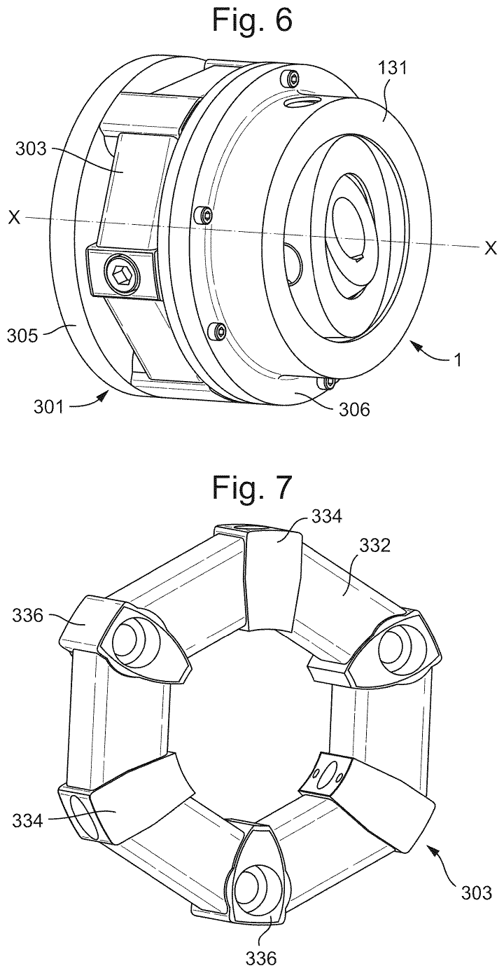

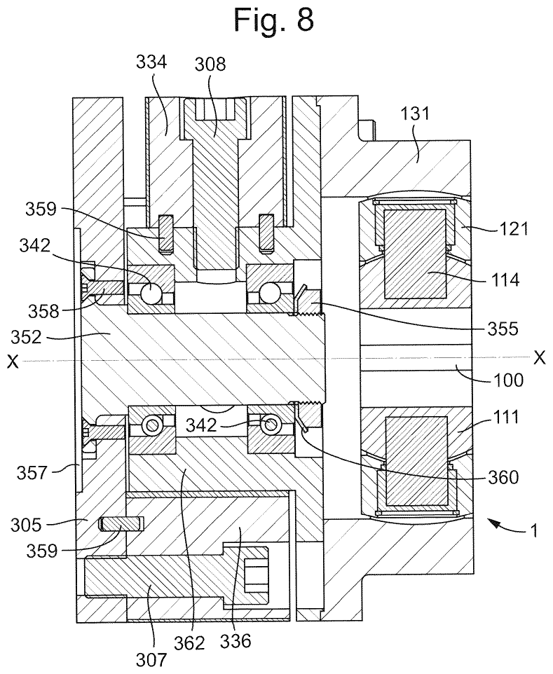

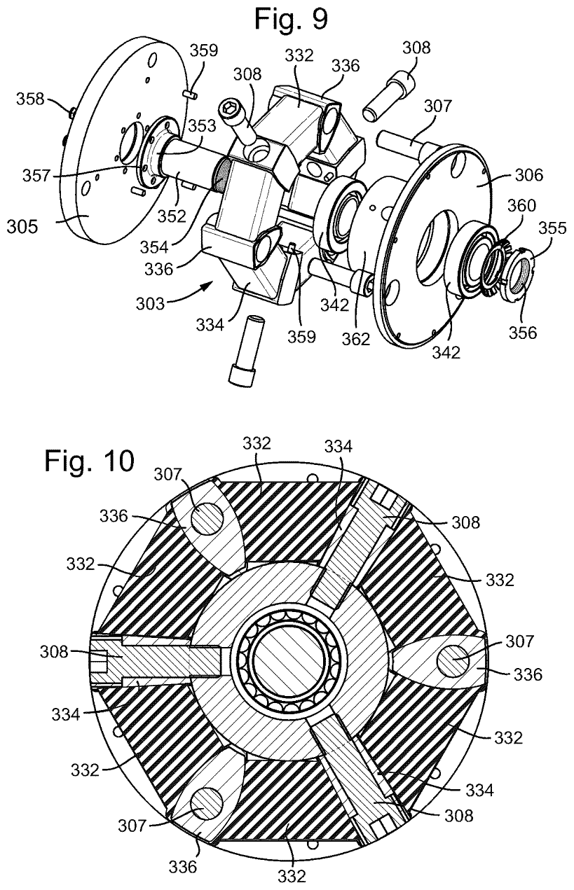

The coupling of FIGS. 1 to 5 may be provided with a pulse damper as illustrated in FIGS. 6 to 10.

The pulse damper 301 has a first end disc shaped plate 305 connectable to a rotatable input drive and a second disc shaped end plate 306 parallel to and opposed to the first end plate 305, both end plates are disposed around the central axis X.

The first end plate 305 has an axle 352 attached to it using a flange 357 and bolts 358. Axle 352 is co-axial with the central axis X and extends from the first end plate 305 towards the second end plate 306.

The second end plate 306 has a tube 362 extending from it co-axially around the axle 352 and forming a housing for a pair of bearings 342 between the tube 362 and the axle 352. The tube 362 is stepped allowing the bearings 342 to be seated. The bearings 342 are held in place at one end of tube 362 by an annular lock nut 355 having an internal screw thread 356 co-operating with an external screw thread 354 around the axle 352. A flared locking washer 360, is placed between the lock nut 355 and one of the pairs of bearings 342. At the other end of tube 362 the bearings are held in place by a stepped portion of axle 352.

A damping ring 303 is disposed around the tube 362. The damping ring 303 is shown in more detail in FIGS. 7 and 10. The damping ring 303 comprises an even number (six in this case) of wedge blocks 334 and 336, forming dividers between elastomeric members 332 disposed equidistantly from one another around the tube 362. The blocks 334 and 336 are separated from one another by elastomeric members 332. Alternate blocks 336 are bolted to the first end plate 305 by bolts 307. In the embodiment of FIGS. 6 to 9, blocks 334 and 336 are wedged shape, with slightly curved side walls.

The blocks 334 between the blocks 336 bolted to the first end plate 305 are bolted with bolts 308 to the co-axial tube 362 (see FIG. 7). The bolts 308 through blocks 334 cause the elastomeric members 332 to bear against the co-axial tube 362. This arrangement forces the damping ring 303 to flex only around the central axis and not radially thus preventing imbalances. As can be seen in FIGS. 6 to 9, the wedge blocks 334 have curved sides adjoining the resilient members the curvature of the sides increasing towards axial tube. This arrangement imposing greater pressure on the resilient members towards their edges ensuring good contact with axial tube.

The compliant connecting elastomeric sections 332 of damping ring 303 absorb the power pulses delivered from, for example, internal combustion engines by continuously and alternately compressing and extending in between the fixed blocks 334 and 336 during operation. Damping ring 3 is an over-moulded component with fixed blocks 334 and 336 restrained in place by the contiguous moulded elastomeric material, over-moulding also prevents overexpansion radially of the elastomeric material in use.

Pins 359 position and retain the blocks 334 in place with respect to the co-axial tube 362. Further pins 359 locate and assist in keeping the blocks 336 in place with respect to the first end plate 305.

Wedge blocks 332 are normally made of aluminium or aluminium alloy for lightness to minimise inertial forces in the flexible coupling

In the illustration, the second end plate 306 is an integral flange machined into the outer member 131 of one of the couplings 1 shown in FIGS. 1 to 4, but it could equally well be bolted to the outer member 131 of coupling 2 shown in FIGS. 1 to 4 or the outer member 351 of the coupling of FIG. 5. If the diameter of the damping means were small enough, the damping means could also be bolted to one of the inner members 111 of couplings 1 and 3 shown in FIGS. 1 to 4 or the inner member 211 in FIG. 5.

1. A coupling comprising:
an inner member, an outer annular member and an intermediate annular member between the inner member and the outer annular member which, when aligned, share a common axis and have a common centre on the common axis;
the inner member comprising a central aperture in which a shaft is engaged; one or a diametrically opposed pair of first axles disposed radially of the common centre coupling the inner member and the intermediate annular member, and constraining the inner member and the intermediate annular member to rotate, one with respect to the other about a second axis perpendicular to the common axis;
one or a diametrically opposed pair of second axles disposed radially of the common centre coupling the outer annular member and the intermediate annular member, and constraining the outer member and the intermediate annular member to rotate, one with respect to the other about a second axis perpendicular to both the common axis and the first axis;
the inner member, intermediate annular and outer annular member being spaced apart with a gap between each of the members and in that the gaps and the concentricity of the intermediate annular member is maintained by the axles being fixed in the one or other of the inner or outer annular member and intermediate annular member and supported in bearings in the other, and wherein
said coupling is one of two such couplings in which the shaft links the central apertures of the inner members of the couplings, with a drive shaft connected to the outer member of one coupling and a driven shaft connected to the outer member of the other coupling.

2. A coupling as claimed in claim 1 wherein the inner member comprises an outer convex periphery, the intermediate annular member comprises an inner concave periphery in which the outer convex periphery of the inner member is received; the outer convex periphery of the inner member and the inner concave periphery of the intermediate annular member share the same common axis when the coupling is aligned; the intermediate member comprising an outer convex periphery, the outer annular member comprising an inner concave periphery in which the outer convex periphery of the intermediate member is received.

3. A coupling as claimed in claim 1 wherein the bearings are in the intermediate annular member, the first axles are fixed in holes in the inner member and supported in two of said bearings, and the second axles are fixed in holes in the outer member and supported in another two of said bearings.

4. A coupling as claimed in claim 1 wherein the second axle(s) have flange(s) engaging against the outer periphery of the outer member.

5. A coupling as claimed in claim 1 in which an axle is supported in one of the bearings, wherein the said bearing is held in place against centrifugal forces by an engagement means engaging the bearing and the adjoining surface.

6. A coupling according to claim 1 additionally comprising:
a pulse damper disposed are around the central axis, said pulse damper comprising a first end plate and a second end plate said end plates being parallel and opposed to one another;
the first end plate being connected an input or output;
the second end plate being connected to the outer annular member;
one of the said end plates having an axle centred on the central axis extending therefrom towards the other of said end plates which has a tube extending therefrom around said axle and co-axial with said axle and forming a housing for a plurality of bearings between the co-axial tube and the axle;
a damping ring having an even number of dividers disposed equidistantly from one another around said co-axial tube, the dividers comprising elastomeric material between them, with alternate dividers being fixed to the first end plate from which the axle extends, the other dividers being fixed to the co-axial tube.

7. A coupling comprising:
an inner member, an outer annular member and an intermediate annular member which, when aligned, share a common axis and have a common centre on the common axis;
one or a diametrically opposed pair of first axles disposed radially of the common centre coupling the inner member and the intermediate annular member, and constraining the inner member and the intermediate annular member to rotate, one with respect to the other about a second axis perpendicular to the common axis;
one or a diametrically opposed pair of second axles disposed radially of the common centre coupling the outer annular member and the intermediate annular member, and constraining the outer member and the intermediate annular member to rotate, one with respect to the other about a second axis perpendicular to both the common axis and the first axis;
the inner member, intermediate annular and outer annular member being spaced apart with a gap between each of the members and in that the gaps and the concentricity of the intermediate annular member is maintained by the axles being fixed in the one or other of the inner or outer annular member and intermediate annular member and supported in bearings in the other of the inner or outer member and intermediate member;
a pulse damper disposed are around the central axis, said pulse damper comprising a first end plate and a second end plate said end plates being parallel and opposed to one another;
the first end plate being connected an input or output;
the second end plate being connected to the outer annular member;
one of the said end plates comprising an axle centred on the central axis extending therefrom towards the other of said end plates which has a tube extending therefrom around said axle and co-axial with said axle and forming a housing for a plurality of bearings between the co-axial tube and the axle;
a damping ring comprising an even number of dividers disposed equidistantly from one another around said co-axial tube, the dividers comprising elastomeric material between them, with alternate dividers being fixed to the first end plate from which the axle extends, the other dividers being fixed to the co-axial tube.
